(19) United States
(12) Patent Application Publication
(10) Pub. No.: US 2021/0264759 A1
(43) Pub. Date: Aug. 26, 2021

(54) Pedestrian Hazard Detection System

(71) Applicants: Ruth Bernard, Brooklyn, NY (US); David Bernard, Brooklyn, NY (US)

(72) Inventors: Ruth Bernard, Brooklyn, NY (US); David Bernard, Brooklyn, NY (US)

(21) Appl. No.: 17/064,184

(22) Filed: Oct. 6, 2020

Related U.S. Application Data
(60) Provisional application No. 62/981,618, filed on Feb. 26, 2020.

(51) Int. Cl. G08B 21/02; G08B 7/06

(52) U.S. Cl. CPC G08B 21/02; G01S 13/93; G08B 7/06

(57) ABSTRACT

A pedestrian hazard detection system. The pedestrian hazard detection system has a housing that is sized and shaped to receive and secure a mobile device, such as a cellphone, therein. At least one sensor, such as a motion sensor, is disposed within the housing. The sensor can detect obstacles that are approaching and are in the vicinity of the housing. The sensor is operably connected to the mobile device and whereupon the sensor detecting the at least one approaching obstacle, a signal is sent to the operably connected mobile device to emit an alert. The alert can notify a user that the obstacle is approaching such that the user can take appropriate action to avoid a collision.

### CROSS REFERENCE TO RELATED APPLICATIONS

This application claims the benefit of U.S. Provisional Application No.

62/981,618 filed on Feb. 26, 2020. The above identified patent application is herein incorporated by reference in its entirety to provide continuity of disclosure.

### BACKGROUND OF THE INVENTION

The present invention relates to hazard detection devices. More particularly, the present invention provides for a pedestrian hazard detection system that can be utilized to alert a user of a potential approaching obstacle via an audio, visual, or haptic stimulus.

Many people become engrossed in personal mobile devices, such as cellphones, to the point where they are not paying attention to their surroundings. Some people engage in activities such as texting, reading, or playing games on their cellphones and are unaware of approaching obstacles such as vehicular traffic. Oftentimes, individuals are so focused on their devices that their inattention can be the source of injury, to themselves or others. For example, an individual may fail to notice an object in their path and trip over it, or they may veer off course potentially into oncoming traffic. If pedestrians were notified of nearby obstacles and hazards, the risk of injuries could be substantially reduced. Therefore, a system that can alert a pedestrian user to local traffic hazards that could pose a significant risk or injury is desired.

Devices have been disclosed in the known art that relate to hazard detection. These include devices that have been patented and disclosed in patent application publications. However, the devices in the known art have several drawbacks. Some devices are bulky and difficult to carry around. Some devices rely on identifying an activity of the user in order to determine whether to activate the detection system or not. If a user is not engaged in a prescribed activity, the system will not turn on and the approaching obstacle may not be recognized or alerted to. Similarly, some systems rely on identifying a level of attentiveness and/or distraction in a user. These systems only work when the user falls within prescribed attentiveness/distraction levels. If the system mis-identifies the level, or the user falls outside the prescribed level, the system will not engage.

The present invention substantially diverges in design elements from the known art and consequently it is clear that there is a need in the art for an improvement to existing hazard detection devices. In this regard the present invention substantially fulfills these needs.

### SUMMARY OF THE INVENTION

In view of the foregoing disadvantages inherent in the known types of hazard detection devices now present in the prior art, the present invention provides a pedestrian hazard detection system that can be utilized to alert a user of a potential approaching obstacle via an audio, visual, or haptic stimulus. The present pedestrian hazard detection system comprises a housing that is sized and shaped to receive and secure a mobile device therein. At least one sensor, such as a motion sensor, is disposed within the housing. The sensor can detect obstacles that are approaching and are in the vicinity of the housing. The sensor is operably connected to the mobile device and whereupon the sensor detecting at least one approaching obstacle, a signal is sent to the operably connected mobile device to emit an alert.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front view of an embodiment of the pedestrian hazard detection system, secured about a cellphone.

FIG. 2 shows a rear perspective view of an embodiment of the pedestrian hazard detection system with representative component parts.

FIG. 3 shows a perspective view of a pair of pedestrian hazard detection systems secured about a pair of cellphones, in use alerting each other of a potential collision.

### DETAILED DESCRIPTION OF THE INVENTION

Reference is made herein to the attached drawings. Like reference numerals are used throughout the drawings to depict like or similar elements of the pedestrian hazard detection system. For the purposes of presenting a brief and clear description of the present invention, a preferred embodiment will be discussed as used for the pedestrian hazard detection system. The figures are intended for representative purposes only and should not be considered to be limiting in any respect.

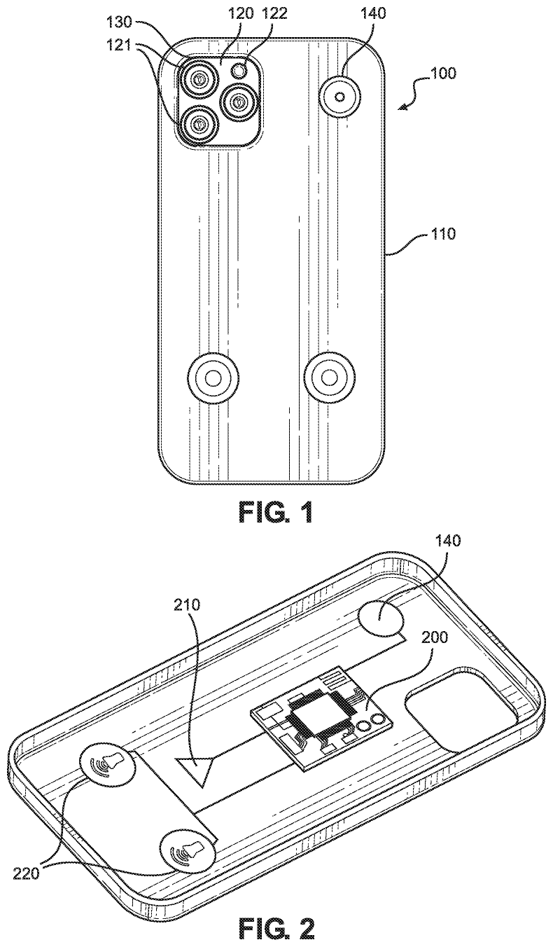

Referring now to FIG. 1, there is shown a front view of an embodiment of the pedestrian hazard detection system, secured about a cellphone. The pedestrian hazard detection system 100 comprises a housing 110 configured to secure a mobile device 120 therein. Although the embodiments shown in the present disclosure enclose a cellphone, other mobile devices 120, such as tablets, are also contemplated. In the shown embodiment, the housing 110 secures the mobile device 120 via a friction fit with a rear and side portions of the mobile device 120. In some embodiments, the housing 110 completely encapsulates the mobile device 120, while in other embodiments (such as the embodiment shown in FIG. 2), the housing 110 does not cover a front surface of the mobile device 120, such that a touch surface of the mobile device 120 can be utilized.

In various embodiments, the housing 110 is composed of a durable and shock-resistant material such that the mobile device 120 is protected from impacts, shocks, and scratches as may occur in the ordinary use of the device. In some embodiments, the material comprises silicone and in some embodiments the material comprises plastic. The present disclosure is riot limited to the types of materials utilized, and similar types of material as can prevent damage to the mobile device 120 as a result of dropping, scratching, or impacting the mobile device 120 are contemplated.

In the shown embodiment, the housing 110 includes a cutout 130 through the housing 110 that is sized and shaped to accommodate and not interfere with the operation of the camera lenses 121 of the mobile device 120. In some embodiments, additional sensors and components of the mobile device 120, such as a fingerprint reader, a camera flash 122, and the like are likewise unobstructed due to the size, shape, and positioning of the cutout 130 on the housing 110. In the shown embodiment, the cutout 130 is square-shaped and is able to accommodate multiple camera lenses 121 and a camera flash 122 at the same time. One of ordinary skill in the art will understand that the size, shape, and location of the cutout 130 on the housing 110 can vary as to suit the size, shape, dimensions, and relative locations of such components on the mobile device 120.

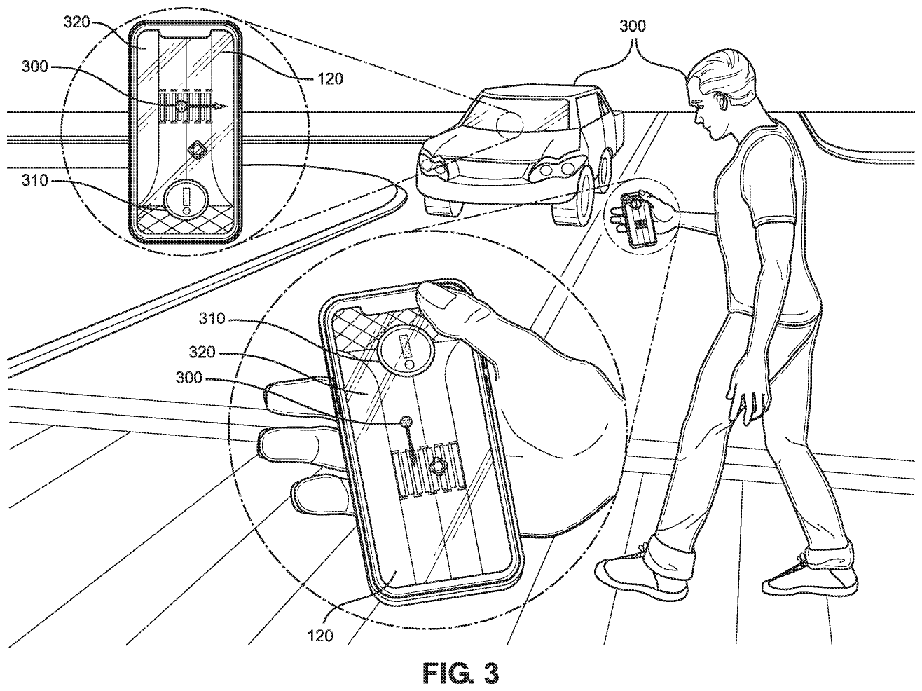

At least one sensor 140 is disposed within the housing 110. The sensor 140 is configured to detect at least one approaching obstacle in the vicinity of the housing (as shown in FIG. 3). The sensor 140 is disposed on the housing 110 such that an area being observed is outside the device, and thus the sensor 140 is disposed on an exterior surface of the housing 110. In various embodiments, multiple sensors 140 can be disposed on the housing, and can be sensors 140 of various types. In some embodiments, the sensor 140 is a motion sensor and is configured to detect any motion of objects observed within a predefined range. In one embodiment, the sensor 140 is configured to determine a speed of the approaching obstacle. In further embodiments, the sensor 140 can operate in the same manner as a radar or a lidar device.

Referring now to FIG. 2, there is shown a rear perspective view of an embodiment of the pedestrian hazard detection system with representative component parts. The sensor 140 is operably connected to the mobile device. In some embodiments, the sensor 140 is connected to the mobile device via a physical plug and receptacle such that a physical electrical connection is formed and communication between the sensor 140 and the mobile device can be accomplished thereby. In the shown embodiment, the sensor 140 is wired to a control circuit 200. In various embodiments, the control circuit 200 includes a wireless transceiver such that wireless communication can occur between the control circuit 200 and a paired mobile device.

In the shown embodiment, a haptic system 210 is disposed in the housing 110 and is electrically connected to the control circuit 200. In other embodiments, the haptic system 210 can be wirelessly connected to the control circuit 200. The haptic system 210 can cause the housing 110 to move or vibrate thereby creating a tactile alert for the user. One of ordinary skill in the art will understand how a haptic system 210 can create an experience of touch by applying forces, vibrations, or movement to a user. In an alternate embodiment, the pedestrian hazard detection system can utilize a haptic system 210 that is already installed in the mobile device. In a further embodiment, the haptic system 210 of the pedestrian hazard detection system can also utilize a haptic system 210 that is already installed in the mobile device in order provide a backup in case one of the systems fails.

In the shown embodiment, a speaker system 220 is disposed in the housing 110 and is electrically connected to the control circuit 200. In other embodiments, the speaker system 220 can be wirelessly connected to the control circuit 200. The speaker system 220 can emit an audio signal from the housing 110 thereby creating an audio alert for the user. Similar to the haptic system 210, the speaker system 220 can be disposed on the housing, or in alternate embodiments, the pedestrian hazard detection system can utilize a speaker system 220 that is already installed in the mobile device. The speaker system 220 of the pedestrian hazard detection system can also serve as a backup to the speaker system 220 that is already installed in the mobile device in the same manner as the haptic system 210.

Referring now to FIG. 3, there is shown a perspective view of a pair of pedestrian hazard detection systems secured about a pair of cellphones, in use alerting each other of a potential collision. Upon the sensor detecting at least one approaching obstacle 300, a signal is sent to the operably connected mobile device 120 to emit an alert 310. In various embodiments, the alert 310 can be a haptic stimulus, an audio stimulus, a visual stimulus, and a combination thereof. In one embodiment, the signal is sent via the wireless transceiver which is operably connected to the control circuit. In this manner, upon the sensor detecting an obstacle, the alert 310 can be displayed visually on the mobile device's screen 320, as well as through a haptic alert and/or an audio alert 310. In some embodiments, as discussed above, the haptic alert 310 can be provided via the haptic system disposed on the pedestrian hazard detection system, and/or through the haptic system of the mobile device. Similarly, in some embodiments, the audio alert 310 can be provided via the speaker system disposed on the pedestrian hazard detection system, and/or through the speaker system of the mobile device. In some embodiments, an intensity of the alert 310 can correspond to a hazard severity level of the approaching obstacle 300. For example, the haptic system can provide various levels of intensity of vibrations, which the speaker system can provide various levels of volume. The hazard severity level can be determined by the control circuit, wherein the control circuit utilizes inputs from the sensor to determine the level. In this manner, where the pedestrian hazard detection system determines that a severe hazard is approaching, a stronger alert 310, such as a strong vibration from the haptic system or a loud volume by the speaker system, can be provided to have a stronger likelihood to get the user's attention.

In the shown embodiment, a driver can be alerted to a pedestrian obstacle 300 via a “!” icon displayed on the driver's cell phone screen 320, and the pedestrian can be alerted to a driver obstacle 300 via a similar “!” icon displayed on the pedestrian's cell phone screen 320. In the shown embodiment, the relative location of the mobile device to the obstacle 300 is shown on a representative map, as well as the direction of travel of the obstacle 300. In some embodiments, the representative map incorporates a GPS signal from the cellphone to provide an accurate map of the surrounding area. In some embodiments, the alert is configured to interrupt a currently active application or software running on the mobile device. In further embodiments, the alert can be superimposed, such as in a pop-up window, or otherwise overlaid on top of any currently active application or software to visually bring the alert to the user's attention.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A pedestrian hazard detection system, comprising:
a housing configured to secure a mobile device therein;
a control circuit disposed within the housing;
at least one sensor disposed within the housing;
the at least one sensor configured to detect at least one approaching obstacle in the vicinity of the housing;
the at least one sensor wirelessly connected to the mobile device;
a housing haptic system disposed within the housing;
a speaker system disposed within the housing;
whereupon the at least one sensor detecting the at least one approaching obstacle causes the control circuit to send a signal to the connected mobile device, the housing haptic system and the speaker system to emit an alert.

2) The pedestrian hazard detection system of claim 1, wherein the at least one sensor is a motion sensor.

3) The pedestrian hazard detection system of claim 1, wherein the at least one sensor is configured to determine a speed of the at least one approaching obstacle.

4) The pedestrian hazard detection system of claim 1, wherein the signal is sent via wireless transceiver.

5) The pedestrian hazard detection system of claim 1, wherein the alert is an audio signal emitted through a speaker system in the mobile device.

6) The pedestrian hazard detection system of claim 1, wherein the alert is a mobile device haptic signal emitted through a pre-existing haptic system in the mobile device.

7) The pedestrian hazard detection system of claim 1, wherein an intensity of the alert corresponds to a hazard severity level of the at least one approaching obstacle.

8) A pedestrian hazard detection system, comprising:
a housing configured to secure a mobile device therein;
a control circuit disposed within the housing;
a housing haptic system disposed within the housing;
at least one sensor disposed within the housing;
the at least one sensor configured to detect at least one approaching obstacle in the vicinity of the housing;
whereupon the at least one sensor detecting the at least one approaching obstacle causes the control circuit to send a signal to the housing haptic system to emit an alert.

9) The pedestrian hazard detection system of claim 7, wherein the at least one sensor is a motion sensor.

10) The pedestrian hazard detection system of claim 7, wherein the at least one sensor is operably connected to the mobile device.

11) The pedestrian hazard detection system of claim 7, wherein an intensity of the alert corresponds to a hazard severity level of the at least one approaching obstacle.

12) A pedestrian hazard detection system, comprising:
a housing configured to secure a mobile device therein;
a control circuit disposed within the housing;
a speaker system disposed within the housing;
at least one sensor disposed within the housing;
the at least one sensor configured to detect at least one approaching obstacle in the vicinity of the housing;
whereupon the at least one sensor detecting the at least one approaching obstacle causes the control circuit to send a signal to the speaker system to emit an alert.

13) The pedestrian hazard detection system of claim 11, wherein the at least one sensor is a motion sensor.

14) The pedestrian hazard detection system of claim 11, wherein the at least one sensor is operably connected to the mobile device.

15) The pedestrian hazard detection system of claim 11, wherein an intensity of the alert corresponds to a hazard severity level of the at least one approaching obstacle.
